(19) United States
(12) Patent Application Publication
(10) Pub. No.: US 2006/0273540 A1
(43) Pub. Date: Dec. 7, 2006

(54) Suspension system for a vehicle

(76) Inventors: Arnold J. Heron, Ajax (CA); Parto Rezania, Scarborough (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 11/143,482

(22) Filed: Jun. 3, 2005

(51) Int. Cl. B60G 9/00; B60G 5/00

(52) U.S. Cl. 280/124.116; 280/124.1; 280/124.11; 280/683

(57) ABSTRACT

A suspension system for wheeled vehicles, particularly trailers, that is mounted underneath the vehicle frame and forward of the axle (in case of a single axle suspension) and both forward and rearward of axles (in case of a tandem axle suspension). The suspension system at each side of the vehicle frame comprises a hanger, a control arm and an elastomer spring. The hanger has a support bracket and a hanger channel and is the frame bracket connecting the suspension to the vehicle frame. The elastomer spring biases the control arm and the hanger and therefore isolates the vibration of the suspended portion of the vehicle (the sprung mass) from that of the axle(s) and wheels (the unsprung mass).

### FIELD OF THE INVENTION

This invention relates generally to suspension systems. More particularly, the invention relates to a suspension system for a vehicle such as a light, or medium duty trailer.

### BACKGROUND OF THE INVENTION

The use of suspension systems for wheeled vehicles such as light to medium duty trailers is well known. Suspension systems are generally a set of components, including springs and shock absorbers, which suspend the vehicle above the wheels to isolate vibration of the sprung mass. Many different suspension systems are available for vehicle owners with the most common types of suspension systems being leaf spring suspensions, air suspensions and/or rubber-torsion-bar suspensions.

Leaf spring suspensions are well known and have been used for a long time. In general, if a solid axle connects the rear wheels of the vehicle, the suspension is usually quite simple and is based on a leaf spring suspension system. The leaf spring clamps directly to the axle while the ends of the leaf spring attach to the frame of the vehicle through hanger brackets. For many years, vehicle manufacturers preferred this design due to its simplicity, but leaf springs suffer from various disadvantages. These disadvantages include a poor quality of ride for the vehicle occupants since a leaf spring suspension system contains little or no energy absorbing medium to dampen shocks and to reduce the natural frequency of vibration of the sprung mass (which is the mass of the vehicle supported on the suspension system). Also, since the spring rate of steel leaf springs is linear, the vibration frequency of the sprung mass may vary significantly from empty to loaded conditions. Furthermore, the suspension system is typically quite noisy since there are many moving joints and parts. Another disadvantage of a leaf spring suspension system is that the system comprises many components which need to be installed together which leads to a need for more regular maintenance. Also, over time, leaf springs deform permanently and once a leaf spring is deformed, its length also changes which causes an equalizer bar to permanently lean to one side reducing the operating range of the suspension system.

With air suspension systems, these are generally less reliable since they are subject to air leaks which may take place within fittings, the tubing, height control valves, inflate/deflate valves, air compressors or the air springs themselves. The performance of an air suspension is dependent on the ability of the system to regulate the air pressure in the air springs which is not an easy task. If there is too much pressure in the air springs of the suspension system, the ride becomes rough but if there is not enough pressure in the air springs, the suspension system is ineffective. Furthermore, due to the size of air springs, they are not adaptable for some applications. Also, for vehicles using air suspension systems, thicker wall axles are preferred which result in heavier and more expensive axles being used.

In rubber torsion-bar suspensions, there is no load equalization for multiple-axle trailers since each torsion-bar suspension works independently of the others. Maintenance and the replacement of damaged or worn parts in a rubber torsion-bar suspension system is also quite difficult such that when a part requires repair, the entire system is generally replaced. The suspension system is also large and bulky which makes it more difficult to store and ship the rubber torsion-bar suspension systems. Furthermore, when the crank arm of the torsion-bar suspension system acts as a cantilever beam, the crank arm experiences combined bending and torsion stresses. In order to reduce the stress level being experienced, the crank arms are generally manufactured quite short. However, these short crank arms require a large range of rotation to provide an adequate amount of spindle travel and therefore, when combined with a predetermined camber causes a wide range of change in toe-in angle. This change in toe-in angle causes an increase in the amount of scrubbing, chafing and/or wearing of tires especially when the vehicle is in a loaded condition.

It is, therefore, desirable to provide a novel suspension system for a vehicle.

### SUMMARY OF THE INVENTION

It is an object of the present invention to obviate or mitigate at least one disadvantage of previous suspension systems for vehicles.

The present invention is directed at a suspension system which endeavours to provide a quieter ride than conventional suspension systems. The pressure and forces which the suspension system experiences during transportation are received and absorbed by an elastomer spring. The elastomer spring provides the necessary elasticity to absorb the forces and operates in a quiet manner thus providing a quieter ride. Furthermore, there are very few parts to the suspension system of the invention and therefore maintenance of the present invention is relatively simple. Moreover, disassembly of the suspension system is quite simple due to the use of fewer parts. The present suspension system is also quite versatile in its use since it may be installed on steel frames as well as on aluminum and composite frames. Furthermore, the suspension systems of the driver and passenger sides are independent compared to various known suspension systems allowing the suspension system to be installed on vehicles with different widths. This also allows the suspension systems to provider greater roll stability.

In a first aspect, the invention provides a suspension system for a vehicle comprising a control arm having an axle end and a hanger end, the axle end configured for mounting the control arm to an axle of the vehicle; a hanger, mounted to the control arm at the hanger end, having means for mounting the suspension system to a frame of the vehicle; and an elastomer spring, located between the control arm and the hanger, away from the axle end of the control arm.

In a further embodiment, there is provided a tandem axle suspension system for a vehicle comprising an equalizer bar; a hanger, mounted to the equalizer bar, for mounting to a frame of the vehicle; a pair of control arms, each connected at an end of the equalizer bar; wherein each of the pair of control arms having an axle end and an equalizer end, the axle end configured for mounting the control arm to an axle of the vehicle; and an elastomer spring, located between each of the pair of control arms and the corresponding end of the equalizer bar, away from the axle end of each of the pair of control arms.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1a is a perspective view of an embodiment of a single axle suspension system in accordance with the invention;

FIG. 1b is a side view of the embodiment of FIG. 1a with an elastomer spring compressed;

FIG. 1c is a side view of the embodiment of FIG. 1a with the elastomer spring uncompressed;

FIG. 2a is a perspective view of a control arm;

FIG. 2b is a side view of the control arm of FIG. 2a;

FIG. 3 is a cross-section taken along line 3-3 of FIG. 2a;

FIG. 4a is a perspective view of an elastomer spring;

FIG. 4b is a top view of the elastomer spring;

FIG. 4c is a cut away view taken along line 4c-4c of FIG. 4b;

FIG. 4d is a top view of a second embodiment of an elastomer spring;

FIG. 4e is a cut away view taken along line 4e-4e of FIG. 4d;

FIG. 5a is a perspective view of a tandem axle suspension system when there is no load on the suspension system;

FIG. 5b is a perspective view of the tandem axle suspension system of FIG. 5a when there is a load on the suspension system;

FIGS. 6a and 6b are schematic illustrations of an equalization process; and

FIG. 7 is a schematic view of different ride heights.

### DETAILED DESCRIPTION

Generally, the present invention provides a novel suspension system for a vehicle.

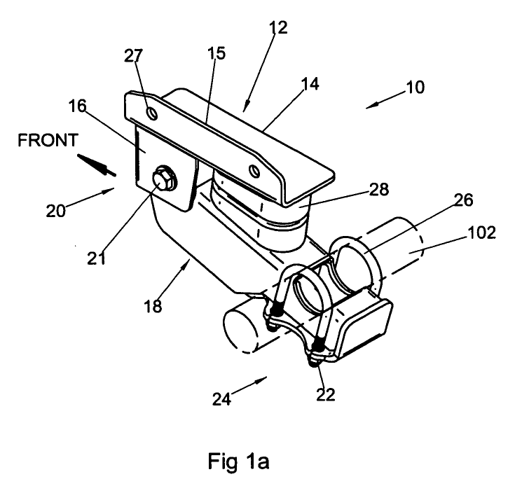

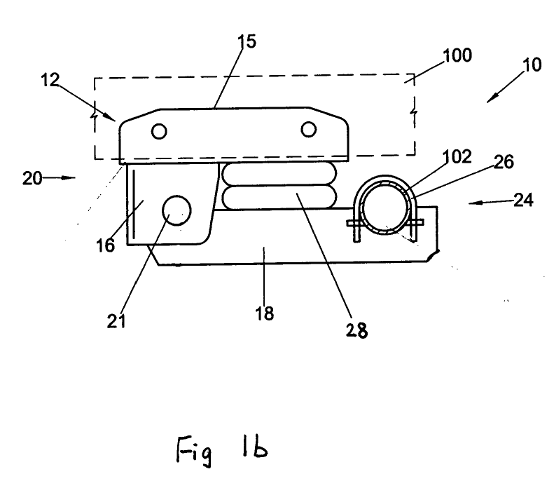

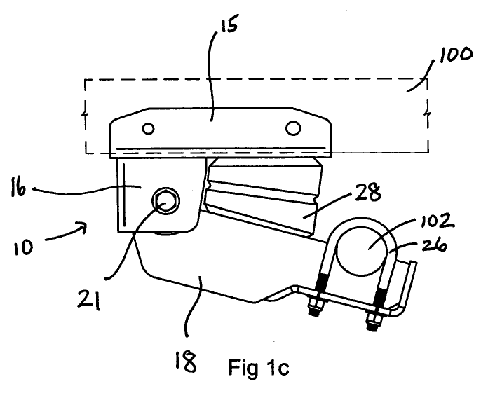

FIGS. 1a to 1c provide, respectively, a perspective view and two side views of a suspension system which is to be installed at one end of an axle of a vehicle. FIG. 1b is a side view of the suspension system with the elastomer spring compressed and FIG. 1c is a side view of the suspension system with the elastomer spring uncompressed.

In the present application, the term suspension system has been used to describe the suspension system for one end of a vehicle axle. However, as will be appreciated by one skilled in the art, a pair of suspension systems are generally mounted at opposite ends of an axle to provide adequate support and stability for a vehicle. The axle is a fixed bar or beam with bearings at its ends to mount the axle to a tire, or wheel, at each end about which the tires rotate. Although it is not common for only one suspension system to be mounted to an axle, this embodiment is contemplated.

In the present embodiment, in which a single axle suspension system is shown, the suspension system 10 comprises a hanger 12, comprising a support bracket 14 (including a mounting plate 15) and a hanger channel 16, connected to a control arm 18 via the hanger channel 16. The support bracket 14 is connected to, preferably by welding, the hanger channel 16 and generally mounted to the under-carriage or side of a vehicle 100 such as a light or medium duty trailer. Although many methods of mounting the suspension system 10 to the vehicle are known, in the preferred embodiment, the suspension system 10 is bolted or welded to the frame of the vehicle.

The control arm 18 is preferably bolted (via fastening means 21, seen as a bolt), at a hanger end 20, to the hanger channel 16 and also includes a set of holes 22 (at an axle end 24) for receiving a pair of U-bolts 26 which are used to assist in mounting the suspension system 10 to an axle 102 of the vehicle frame 100. Other fastening means 21 such as a pin or a stud may also be used. The control arm acts as a trailing arm connecting the axle 102 of the vehicle to the hanger channel 16 causing isolation of the vibration of the axle of the vehicle (when the vehicle is in motion) from the sprung mass (which is the mass of the vehicle supported on the suspension system).

As will be understood by one skilled in the art, the suspension system shown in FIG. 1 a is for a tire located on the driver side of the vehicle. The axle end 24 of the control arm 18 is located closer to the rear of the vehicle (with respect to the hanger channel 16), so that the mounting plate 15 (via the mounting holes 27) is mounted to a side of the trailer frame using fastening means. A similarly shaped suspension system (with the difference being the position of the mounting plate 15 of the support bracket 14) is mounted to the opposite (or passenger side) end of the axle to provide a complete suspension system at both ends of the axle as is normally provided for vehicles. The mounting of the axle to a wheel is well known.

The mounting of the suspension system 10 to the axle 102 will be known to one skilled in the art and one example of how the suspension system is mounted to an axle is shown in FIG. 1b. The curved portion of the U-bolts 26 conforms to the shape of the axle tube and assists in locking the axle 102 in place atop the axle end 24 of the control arm 18.

An elastomer spring 28, such as one manufactured under the trade name AEON® by TIMBREN Industries Incorporated of Ajax, Ontario, Canada, is located between the bottom surface of the support bracket 14 and the top surface of the control arm 18. Although described as an elastomer spring, the spring is preferably manufactured from natural rubber but may also be manufactured from urethane, micro-cellular urethane or other like materials. Unlike some conventional suspension systems where the spring is located over the axle of the vehicle, the location of the elastomer spring 28 in the present invention is away from the axle end 24 of the control arm 18. The spring 28 absorbs the vertical force or forces which occur while the vehicle is moving, or stationary, in order to protect other parts of the vehicle such as the axle from damage or wear and tear due to the substantial forces being applied to these parts. The spring 28 also assists in providing a more protected method of transporting goods in a trailer. Furthermore, the use of the elastomer spring 28 provides a quieter ride since there is no metal on metal contact between moving parts as is present with some other conventional suspension systems.

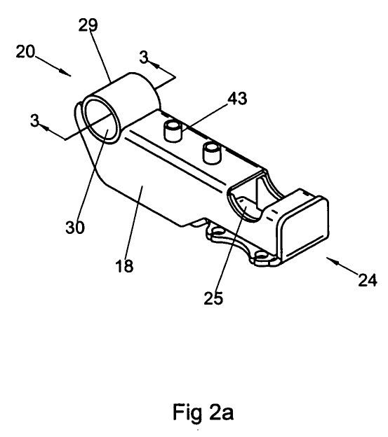

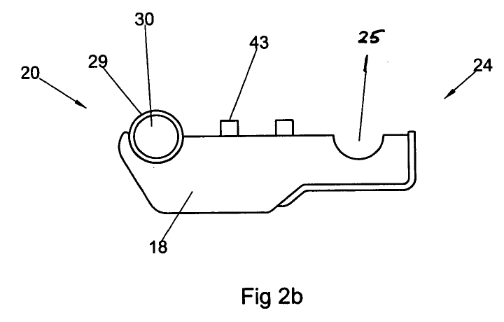

As shown in FIGS. 2a and 2b, a perspective view and a side view of the control arm are provided. In these figures, the hanger end 20 and the axle end 24 of the control arm 18 are more clearly shown. At the axle end 24, the suspension system 10 is mounted to the axle of a vehicle by locating the axle on a saddle-shaped portion 25 of the control arm 18 and inserted U-bolts 26. The U-bolts, then by gravity, come to rest around the axle and lock the axle in place as shown in FIG. 1b with the assistance of a number of washers and nuts.

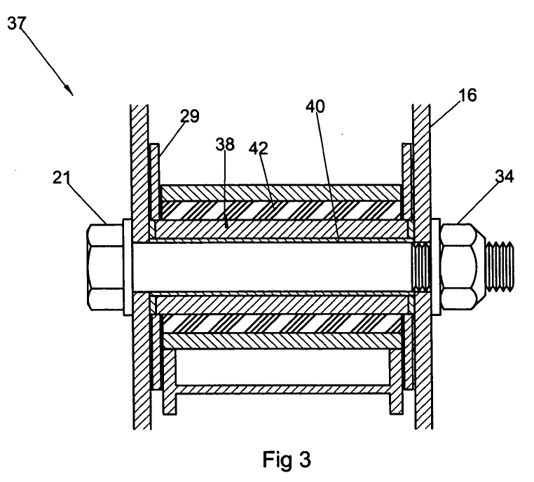

The hanger end 20, comprises a tube 29, preferably of metal, having an inner hole 30 for receiving the fastening means 21 (as shown in FIG. 1a). A control arm bushing 37 (described with respect to FIG. 3) is preferably press fitted into the hole 30 of tube 29 and also includes an inner hole for receiving the fastening means 21. The axis of the circular tube 29 also represents an axis about which the control arm 18 pivots when a vertical force is applied to the suspension system 10. As will be understood, when the suspension system 10 experiences a downward force from the vehicle, the support bracket 14 of the hanger 12 moves with respect to the control arm 18 or else the suspension system 10 may break or be damaged. Therefore, as the elastomer spring 28 absorbs the forces exerted on the suspension system, some of the force is also absorbed by the control arm bushing 37. This is described in further detail below.

In order to secure the control arm 18 to the hanger channel 16 of the hanger 12, the hanger channel 16 and the control arm 18 are aligned so that holes in the hanger are aligned with the hole 30 in the tube 29 and the hole in the control arm bushing 37. Both the tube 29 and the control arm bushing 37 rest between the inner walls of the hanger channel 16. Once aligned, the bolt is placed through the holes and secured via a nut 34 or any other fastening member.

As shown in cross-section in FIG. 3 (taken along line 3-3 of FIG. 2a), the control arm bushing 37 comprises a tube (preferably of steel) 38 and a circular layer of an elastomer material (such as rubber) 42 surrounding the tube 38. The layer of elastomer 42 is preferably moulded to the outer surface of the tube 38. The tube 38 also encircles the fastening means 21. The fastening means 21 is protected from the inside hole of the tube 38 by a cylindrical sleeve 40, preferably manufactured from nylon, however, other materials such as ultra-high molecular weight (UHMW) polyethylene or rubber may also be used. The circular layer of elastomer material 42 provides elasticity to the suspension system 10 to absorb the vertical forces experienced at the hanger channel 16 allowing control arm 18 to pivot with respect to the hanger channel 16. The layer of elastomer 42 also assist in transferring lateral loads of axle 102 to the hanger 12 through a shock absorbing material allowing the hanger 12 to pivot with respect to the control arm 18. The inner surface of the tube 29 is also protected from the outer surface of the tube 38 by the layer of elastomer 42.

The control arm 18 also includes means 43 for locating the elastomer spring, which in the preferred embodiment is shown as a pair of guides on the top surface of the control arm 18.

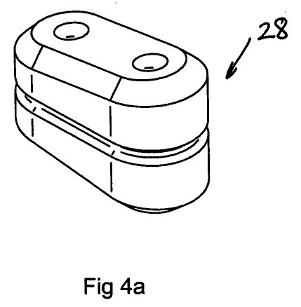

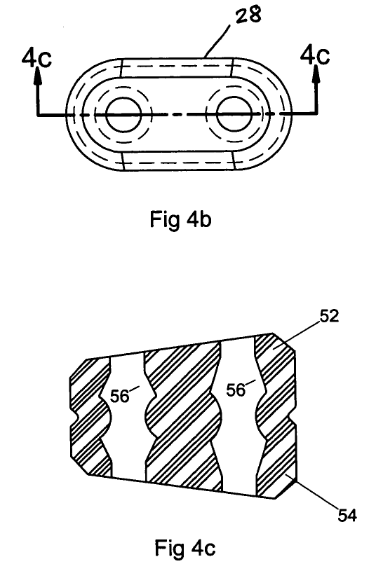

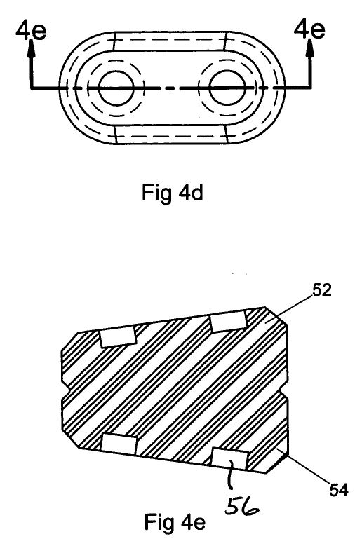

In FIG. 4a, a perspective view of the elastomer spring is provided while in FIG. 4b, a top view of the elastomer spring is shown. The elastomer spring 28 preferably has a top portion 52 and a bottom portion 54 although, as can be seen in FIG. 4c (which is a cross-section taken along line 4c-4c of FIG. 4b), the elastomer spring is preferably of one-piece construction. The elastomer spring preferably includes a pair of holes 56 in which the means 43 for locating the spring are inserted in order to locate the spring during the assembly process. As indicated above, the positioning of the spring 28 with respect to the control arm (i.e. away from the axle end) is an advantage over prior art suspension systems. The shape of the elastomer spring (in the preferred embodiment), allows the axle to have more space above it which allows lower ride heights to be experienced. The shape of the spring also allows for the ride quality to be improved since the frequency of vibration is lowered.

FIG. 4d and 4e provide views of a second embodiment of an elastomer spring which may be used with the suspension system. In this embodiment, the size of the holes 56 for the guides are reduced to provide more elastomer material to assist in absorbing the forces.

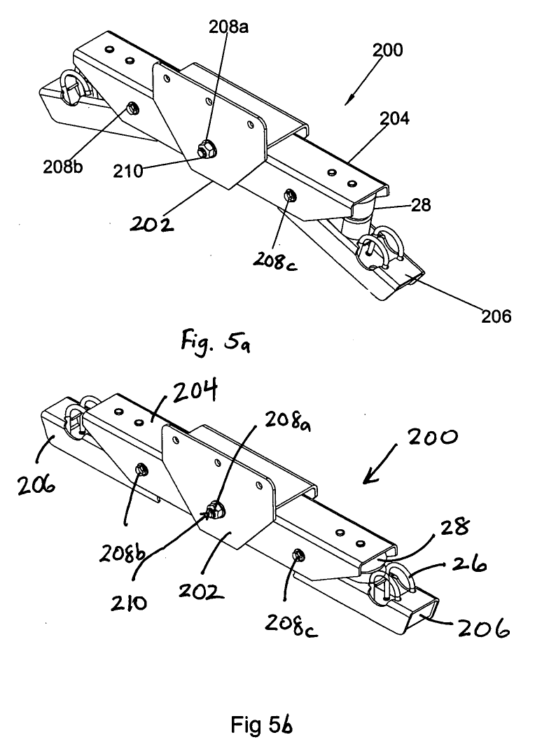

Turning to FIGS. 5a and 5b, another embodiment of a suspension system in accordance with the invention is shown. In this embodiment, the suspension system is for a tandem axle configuration. The suspension system is designed for vehicles which have tandem axles connecting a set of at least four wheels. FIG. 5a shows the tandem axle suspension system when there is no load on the suspension system while FIG. 5b shows the tandem axle suspension system when there is a load on the suspension system.

The tandem axle suspension system 200 comprises a hanger 202 which is connected to an equalizer bar 204 which, in turn, is connected at each end to a control arm 206. An elastomer spring 28 is located between each end of the equalizer bar 204, connected at its top surface to the equalizer bar 204 and at its bottom surface to the respective control arm.

The hanger 202 is a rigid interface between the frame of the vehicle 210, or trailer, and the rest of the suspension system 200 and is preferably attached to the frame of the vehicle or trailer by welding, bolting or riveting but other mounting methods are also known and contemplated.

The equalizer bar 204 is a beam or bar with a set of joints 208 (preferably three) for pivoting which assists in balancing (equalizing) the load being experienced by the tandem axles so that there is an even distribution of load between the two axles during operation of the vehicle. One of the joints 208a is located in the middle of the equalizer bar 204, and the other two joints 208b and 208c are located at opposite and equally spaced distances from the middle joint 208a. The equalizer bar 204 is connected to the hanger via fastening means 210 at the middle joint 208a and is able to articulate, or rotate about that axis.

The control arms 206 located at opposite ends of the equalizer bar are similar to the control arms 18 described above. The difference being that the hanger 12 is replaced by the ends of the equalizer bar 204. The control arm 206 also includes a control arm bushing (not shown) which operates in a manner similar to the one described above at an equalizer end of the control arm 206.

Similar to the control arm bushing 37 described above, an equalizer bushing is located in the axis of the middle joint 208a. The fastening means, seen as a bolt, 210 which fastens the hanger 202 to the equalizer bar 204 is inserted through the equalizer bushing (which is located in the under-carriage of the equalizer bar) and then fasten on the other side to lock the equalizer bushing in place. As with the control arm bushing, the equalizer bushing provides further assistance in absorbing the forces experienced by the suspension system during use.

The equalizer bushing allows the equalizer bar 204 to articulate and also acts as an interface to transfer the load being experienced on the tandem axle to the hanger 202 through a flexible member to improve ride quality and to prolong the life of the suspension system and axle.

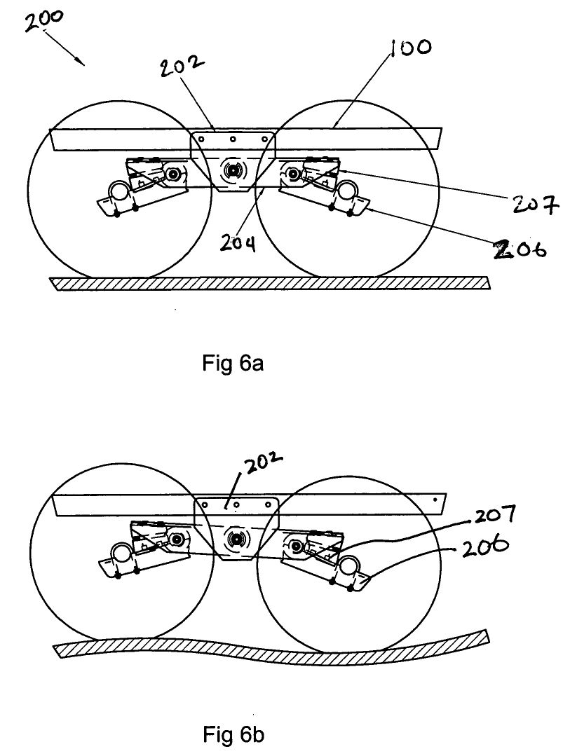

This equalization process is shown with respect to FIGS. 6a and 6b. FIG. 6a shown the tandem axle suspension system in operation on even ground while FIG. 6b shows the tandem axle suspension system in operation on uneven ground.

On even ground, the equalizer bar 204 remains parallel to the frame of the vehicle (when the vehicle is level) in order to distribute the load evenly. However, when the tandem axle system is in operation on uneven ground, the equalizer bushing allows the equalizer bar 204 to adjust itself in accordance with the profile of the ground. In operation, the equalizer bar 204 articulates and adjusts the position of the tandem axles relative to the frame of the vehicle until there is conformity between the profile of the ground and the location of the axles. This allows both tires to stay on the uneven ground and maintains equal loads between the axles so that one axle will not be more overloaded than the other (as long as the equalizer bar 204 is free to articulate. This assists to reduce the stress on the suspension systems parts and minimizes twisting and undue stress on the frame of the vehicle.

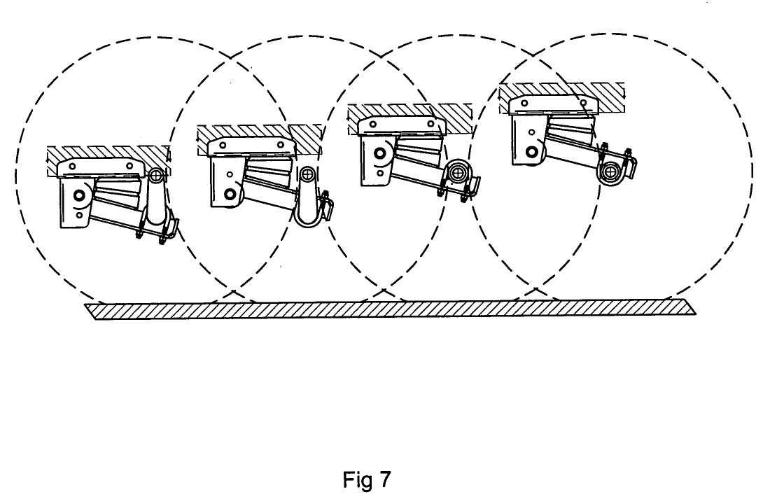

Another advantage of the invention is that the ride height (vertical distance from the centre of the spindle to the bottom of the vehicle frame) may be easily changed by inverting the control arm causing the suspension system to be bottom mounted (axle is below control arm) rather than top mounted (as described). FIG. 7 provides a schematic view of different ride heights which may be achieved with the suspension system of the invention.

In each of the embodiments, the elastomer spring is preferably tapered-shape and generally designed to match/mate with the contours and shape of the surface with which it is fastened or abutting. The tapered shape of the elastomer spring is designed to be consistent with the range of articulation of the control arm and the geometry of the suspension system. The compact design of the spring provides an advantage in that the spring may be located closer to the outboard of the frame of the vehicle to maximize the roll stability of the trailer. The reduced footprint width of the spring also allows the suspension system to have a narrower width and therefore be designed lighter, making it possible to minimize the unsprung mass of the suspension system and to achieve better ride quality. In use, as the vertical load on the axle increases, the spring deforms in a gradual manner (in accordance with the load) and its spring rate progressively increases, its height shortens and the pressure on the spring surfaces contacting the support bracket and the control arm increases. This increased pressure is distributed over the length of the spring to produce a resultant force that counteracts with the axle load to establish a new stable position for the control arm 18 and the axle with respect to the frame of the vehicle.

In another embodiment, although described with U-bolts, other methods of mounting the suspension system to the axle of the vehicle are contemplated which allow a rigid or semi-rigid connection to be achieved between the suspension system and the axle. These methods include, but are not limited to, welding, bolting, clamping or press-fitting.

One other advantage of the suspension system of the present invention is that it is easy to install to a vehicle since there is only a single hanger to install to the vehicle at each end of the axle.

As is understood, although a pair of suspension systems are generally required to be installed at opposite ends of the axle, the suspension systems are independent from each other and therefore can be packaged separated. This provides an improvement over conventional suspension systems which are large and bulky.

Another advantage is that the suspension system of the present invention can be easily disassembled. Damaged or worn parts may be very quickly and easily replaced.

The modular assembly design also allows the metal parts of the suspension system be easily rust proofed (if necessary) along with other processes such as painting, e-coating, plating, galvanizing etc.

Another advantage of the suspension system is that it is quiet since there are fewer moving parts and also no metal on metal contact.

The suspension system of the present invention also requires very little or no maintenance since elastomer springs, especially rubber springs, have been proven to be long lasting and are relatively unaffected by changes in climates or environments.

Although described with respect to single axles, the suspension system may also be mounted on drop axles. The suspension system may also be mounted on any vehicle frame such as steel, aluminium or a composite frames.

Advantages are also experienced with the tandem axle suspension system in that the suspension system is fully equalized. Equalization is known as the ability of a suspension system to distribute the combined load of an axle group equally at all times between individual axles so that any load (downward force) which is being experienced by the axles is equally distributed to the multiple control arms. This also reduces the amount of stress which is experienced by the parts of the suspension system to prolong the life of these components.

Another advantage of the tandem axle suspension system is the ease with which the axles may be aligned. Since the driver side and passenger side suspension systems are pre-assembled and the distance between axles pre-determined, there will be parallelism in the positioning of the axles and the suspensions systems by design during installation of the axles.

Although directed at light and medium duty trailers, it will be understood that since vehicles may have different axle sizes, the axle end of the control arm may be manufactured to accordingly mate with any axle.

Also, although the suspension system of the invention is geared towards trailers, the suspension system may be installed in vehicles such as cars.

In an alternative embodiment, the control arm bushing 37 or the equalizer bushing may be moulded to the control arm and does not have to be press fitted.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A suspension system for a vehicle, comprising:
a control arm having an axle end and a hanger end, said axle end configured for mounting said control arm to an axle of said vehicle;
a hanger, mounted to said control arm at said hanger end, having means for mounting said suspension system to a frame of said vehicle; and
an elastomer spring, located between said control arm and said hanger, away from said axle end of said control arm.

2. The suspension system of claim 1 further comprising a control arm bushing, housed by said control arm at said hanger end, providing a pivot point about which said suspension system pivots.

3. The suspension system of claim 1 wherein said elastomer spring is manufactured from natural rubber, urethane, or micro-cellular urethane.

4. The suspension system of claim 2 wherein said control arm comprises a tube located at said hanger end.

5. The suspension system of claim 4 wherein said control arm bushing is press-fitted within said tube.

6. The suspension system of claim 2 wherein said control arm bushing comprises:
a metal tube; and
a circular layer of elastomer, surrounding said metal tube.

7. The suspension system of claim 5 wherein said control arm bushing comprises:
a metal tube; and
a circular layer of elastomer, surrounding around said metal tube.

8. The suspension system of claim 7 wherein said hanger is mounted to said control arm via fastening means.

9. The suspension system of claim 8 wherein said fastening means is a nut and bolt.

10. The suspension system of claim 7 wherein said control arm bushing further comprises a sleeve located within said metal tube for housing said bolt.

11. The suspension system of claim 1 further comprising a set of U-bolts, located at said axle end of said control arm for mounting said control arm to said axle.

12. A tandem axle suspension system for a vehicle, comprising:
an equalizer bar;
a hanger, mounted to said equalizer bar, for mounting to a frame of said vehicle;
a pair of control arms, each connected at an end of said equalizer bar; wherein each of said pair of control arms having an axle end and an equalizer end, said axle end configured for mounting said control arm to an axle of said vehicle; and
an elastomer spring, located between each of said pair of control arms and said corresponding end of said equalizer bar, away from said axle end of each of said pair of control arms.

13. The tandem axle suspension system of claim 12 further comprising a control arm bushing for each of said pair of control arms, housed by each of said control arm at said equalizer end, providing a pivot point about which said suspension system pivots.

14. The tandem axle suspension system of claim 12 further comprising an equalizer bushing, located between said hanger and said equalizer bar, for distributing a load experienced by said suspension system over said axle.

15. The suspension system of claim 1 wherein said hanger comprises:
a support bracket for mounting said suspension system to said vehicle; and
a hanger channel for mounting said hanger to said control arm.

16. The suspension system of claim 1 wherein said control arm further comprises means for locating said elastomer spring.
